(19) United States
(12) Patent Application Publication
(10) Pub. No.: US 2012/0097307 A1
(43) Pub. Date: Apr. 26, 2012

(54) Tire for Heavy Vehicles Comprising a Layer of Peripheral Reinforcement Elements

(75) Inventors: Joël Delebecq, La Roche Blanche (FR); Gilles Godeau, Clermont-Ferrand (FR)

(73) Assignees: Michelin Recherche et Technique S.A., Granges-Paccot (CH); Societe de Technologie Michelin, Clermont-Ferrand (FR)

(21) Appl. No.: 13/263,655

(22) PCT Filed: Apr. 6, 2010
(86) PCT No.: PCT/EP2010/054532

§ 371 Date: Dec. 30, 2011

(30) Foreign Application Priority Data
Apr. 7, 2009 (FR) 0952260

(51) Int. Cl. B60C 9/18

(52) U.S. Cl. 152/527

(57) ABSTRACT

A tire with radial carcass reinforcement comprising a crown reinforcement formed of at least two working crown layers, itself radially capped by a tread, the said tread being connected to two beads by two sidewalls, and the crown reinforcement comprising at least one layer of circumferential reinforcing elements. The ratio of the thickness of the crown block at a shoulder end to the thickness of the crown block in the circumferential median plane is greater than 1.20 and the ratio of the distance between the extreme wear surface and the reinforcing elements of the layer of circumferential reinforcing elements in the circumferential median plane to the distance between the extreme wear surface and the reinforcing elements of the layer of circumferential reinforcing elements at the ends of the layer of circumferential reinforcing elements is comprised between 0.95 and 1.05.

The present invention relates to a tire with a radial carcass reinforcement and more particularly to a tire intended to be fitted to vehicles that carry heavy loads and drive at a sustained speed, such as, for example, lorries, tractors, trailers or buses that go on the road.

Reinforcements or reinforcing structures for tires, and particularly for tires of vehicles of the heavy-goods type, are currently—and usually—made up of a stack of one or more plies conventionally known as “carcass plies”, “crown plies”, etc. This way of naming the reinforcements stems from the method of manufacture which consists in producing a series of semi-finished products in the form of plies, provided with threadlike reinforcing elements, often longitudinal, which are then assembled or stacked in order to build a tire preform. The plies are produced flat, with large dimensions, and then cut to suit the dimensions of a given product. The plies are also assembled, initially, substantially flat. The preform thus produced is then shaped into the toroidal profile typical of tires. The semi-finished products known as “finishing” products are then applied to the preform, in order to obtain a product that is ready to be vulcanized.

A “conventional” type of method such as this entails, particularly during the phase of manufacturing the tire preform, the use of an anchoring element (generally a bead wire) which is used to anchor or secure the carcass reinforcement in the region of the beads of the tire. Thus, in this type of method, a portion of all the plies (or just some of the plies) that make up the carcass reinforcement is wrapped around a bead wire positioned in the bead of the tire. Thus, the carcass reinforcement is anchored in the bead.

The fact that this conventional type of method is widespread throughout the tire-manufacturing industry, in spite of there being numerous alternative ways of producing the plies and the assemblies, has led those skilled in the art to employ a vocabulary hinged on the method; hence the terminology generally accepted which in particular includes the terms “plies”, “carcass”, “bead wire”, “shaping” to denote the change from a flat profile to a toroidal profile, etc.

Nowadays, there are tires which do not, strictly speaking, have any “plies” or “bead wires” consistent with the above definitions. For example, document EP 0 582 196 describes tires manufactured without the use of semi-finished products in the form of plies. For example, the reinforcing elements of the various reinforcing structures are applied directly to the adjacent layers of rubber compounds, all of this being applied in successive layers to a toroidal core the shape of which allows a profile similar to the final profile of the tire being manufactured to be obtained directly. Thus, in this case, there are no longer any “semi-finished” products, or any “plies”, or any “bead wires”. The base products, such as the rubber compounds and the reinforcing elements in the form of threads or filaments, are applied directly to the core. Because this core is of toroidal shape, there is no longer any need to shape the preform in order to change from a flat profile to a profile in the shape of a torus.

Furthermore, the tires described in that document do not have any “traditional” wrapping of the carcass ply around a bead wire. That type of anchorage is replaced by an arrangement whereby circumferential threads are positioned adjacent to the said sidewall reinforcing structure, everything being embedded in an anchoring or bonding rubber compound.

There are also methods of assembly onto a toroidal core that employ semi-finished products specifically adapted for rapid, effective and simple placement onto a central core. Finally, it is also possible to use a hybrid comprising both certain semi-finished products for achieving certain architectural aspects (such as plies, bead wires, etc.) while others are achieved by applying compounds and/or reinforcing elements directly.

In this document, in order to take account of recent technological evolutions both in the field of manufacture and in the design of products, the conventional terms such as “plies”, “bead wires”, etc. are advantageously replaced by terms which are neutral or independent of the type of method used. Thus, the term “carcass-type reinforcement” or “sidewall reinforcement” can be used to denote the reinforcing elements of a carcass ply in the conventional method and the corresponding reinforcing elements, generally applied to the sidewalls, of a tire produced according to a method that does not involve semi-finished products. The term “anchoring region”, for its part, can denote the “traditional” wrapping of the carcass ply around a bead wire in a conventional method, just as easily as it can denote the assembly formed by the circumferential reinforcing elements, the rubber compound and the adjacent sidewall reinforcing portions of a bottom region produced using a method that involves application onto a toroidal core.

Generally, in tires of the heavy-goods type, the carcass reinforcement is anchored on each side in the bead region and is radially surmounted by a crown reinforcement consisting of at least two layers, which are superposed and formed of threads or cords that are parallel within each layer and crossed from one layer to the next, making angles comprised between 10° and 45° with the circumferential direction. The said working layers, that form the working reinforcement, may also be covered with at least one layer known as a protective layer and formed of reinforcing elements that are advantageously metal and are extensible, known as elastic elements. It may also comprise a layer of metal threads or cords of low extensibility making an angle comprised between 45° and 90° with the circumferential direction, this ply, known as the triangulation ply, being situated radially between the carcass reinforcement and the first crown ply known as the working ply, formed of parallel threads or cords at angles of at most 45° in terms of absolute value. The triangulation ply forms, with at least the said working ply, a triangulated reinforcement which, under the various stresses to which it is subjected, suffers little by way of deformation, the triangulation ply having the essential role of reacting the transverse compressive loads to which the collection of reinforcing elements is subjected in the region of the crown of the tire.

In the case of tires for “heavy-goods” vehicles, just one protective layer is usually present and its protective elements are, in most cases, oriented in the same direction and at the same angle in terms of absolute value as those of the reinforcing elements of the radially outermost and therefore radially adjacent working layer. In the case of construction machinery tires intended to run over fairly uneven ground, the presence of two protective layers is advantageous, the reinforcing elements being crossed from one layer to the next and the reinforcing elements in the radially inner protective layer being crossed with the inextensible reinforcing elements in the radially outer working layer and adjacent to the said radially inner protective layer.

Cords are said to be inextensible when the said cords exhibit a relative elongation of at most 0.2% under a tensile force equal to 10% of the breaking strength.

Cords are said to be elastic when the said cords exhibit a relative elongation of at least 3% under a tensile force equal to the breaking strength, with a maximum tangent modulus of less than 150 GPa.

Circumferential reinforcing elements are reinforcing elements which make angles comprised in the range +2.5°, −2.5° about 0° with the circumferential direction.

The circumferential direction of the tire, or longitudinal direction, is the direction corresponding to the periphery of the tire and defined by the direction in which the tire runs.

The transverse or axial direction of the tire is parallel to the axis of rotation of the tire.

The radial direction is a direction that intersects the axis of rotation of the tire and is perpendicular thereto.

The axis of rotation of the tire is the axis about which it rotates under normal use.

A radial or meridian plane is a plane which contains the axis of rotation of the tire.

The circumferential median plane, or equatorial plane, is a plane perpendicular to the axis of rotation of the tire and which divides the tire into two halves.

Certain current tires known as “road” tires, are intended to run at high speed for increasingly long distances because of improvements to the road network, and because of the growth of the motorway network throughout the world. All of the conditions under which a tire such as this is called upon to run undoubtedly allows the number of kilometers covered to be increased, as tire wear is lower, but on the other hand the endurance of this tire, and particularly of the crown reinforcement, is thereby penalized.

This is because there are stresses in the crown reinforcement and, more particularly, shear stresses between the crown layers, combined with a not-insignificant increase in the operating temperature at the ends of the axially shortest crown layer, which cause cracks to appear and spread in the rubber at the said ends. The same problem is encountered in the edges of two layers of reinforcing elements, the said other layer not necessarily being radially adjacent to the first.

In order to improve the endurance of the crown reinforcement of the type of tire under investigation, solutions relating to the structure and quality of the layers and/or profiled elements of rubber compounds positioned between and/or around the ends of the plies and more particularly the ends of the axially shortest ply have already been provided.

Patent FR 1 389 428, in order to improve the resistance to degradation of the rubber compounds situated near the edges of the crown reinforcement, recommends the use, in combination with a low-hysteresis tread, of a rubber profiled element that covers at least the sides and marginal edges of the crown reinforcement and consists of a low-hysteresis rubber compound.

Patent FR 2 222 232, in order to avoid separations between the crown reinforcement plies, teaches coating the ends of the reinforcement in a cushion of rubber, the Shore A hardness of which differs from that of the tread surmounting the said reinforcement, and which is higher than the Shore A hardness of the profiled element of rubber compound positioned between the edges of crown reinforcement and carcass reinforcement plies.

French application FR 2 728 510 proposes the placement, on the one hand between the carcass reinforcement and the crown reinforcement working ply radially closest to the axis of rotation, of an axially continuous ply formed of inextensible metal cords making an angle of at least 60° with the circumferential direction and the axial width of which is at least equal to the axial width of the shortest working crown ply and, on the other hand, between the two working crown plies, of an additional ply formed of metal elements oriented substantially parallel to the circumferential direction.

Prolonged running under particularly severe conditions of the tires thus constructed has revealed limits in terms of the endurance of these tires.

In order to remedy such disadvantages and improve the endurance of the crown reinforcement of these tires, it has been proposed that there be combined with the working crown layers at an angle at least one additional layer of reinforcing elements substantially parallel to the circumferential direction. Patent application WO 99/24269 notably proposes, on each side of the equatorial plane and in the immediate axial continuation of the additional ply of reinforcing elements substantially parallel to the circumferential direction, for the two working crown plies formed of reinforcing elements that are crossed from one ply to the next, to be coupled over a certain axial distance and then dissociated or uncoupled using profiled elements of rubber compound at least over the remainder of the width common to the said two working plies.

One objective of the invention is to provide tires for “heavy” vehicles, the endurance performances of which are maintained in road use and the weight of which is reduced by comparison with conventional tires.

This object is achieved according to the invention, using a tire with radial carcass reinforcement comprising a crown reinforcement formed of at least two working crown layers of inextensible reinforcing elements, which are crossed from one ply to the other making angles of between 10° and 45° with the circumferential direction, itself radially capped by a tread, the said tread being connected to two beads by two sidewalls, the crown reinforcement comprising at least one layer of circumferential reinforcing elements, the ratio of the thickness of the crown block at a shoulder end to the thickness of the crown block in the circumferential median plane being greater than 1.20 and the ratio of the distance between the extreme wear surface and the reinforcing elements of the layer of circumferential reinforcing elements in the circumferential median plane to the distance between the extreme wear surface and the reinforcing elements of the layer of circumferential reinforcing elements at the ends of the said layer of circumferential reinforcing elements being comprised between 0.95 and 1.05.

A shoulder end is defined, in the shoulder region of the tire, by the orthogonal projection onto the exterior surface of the tire of the intersection of the tangents to the surfaces of an axial outer end of the tread (top of the tread patterns) on the one hand, and of the radially outer end of a sidewall on the other hand.

The thickness of the crown block in the circumferential median plane is defined as being the distance in the radial direction between the tangent to the top of the tread in the circumferential median plane and the tangent to the radially innermost rubber compound of the tire, in the circumferential median plane.

The thickness of the crown block at a shoulder end is defined by the length of the orthogonal projection of the shoulder end onto the layer of rubber compound radially furthest towards the inside of the tire.

The extreme wear surface of a tire is defined within the meaning of the invention as being the surface extrapolated from the wear indicators present in the tire.

The distances between the extreme wear surface and the reinforcing elements of the layer of circumferential reinforcing elements are measured along the normal to the exterior surface of the tread that passes through the relevant measurement point for the layer of circumferential reinforcing elements.

The various measurements are taken on a cross section of a tire, the tire therefore being in an uninflated state.

The tire thus defined according to the invention makes it possible, for a given size, to maintain satisfactory tire performance in road use in terms of endurance and wear rate, the tire being substantially lighter in weight.

As compared with a conventional tire of the same size, the tire according to the invention exhibits markedly smaller crown block thicknesses in the region centered on the circumferential median plane.

In terms of the architecture of the reinforcement in the region of the crown block, that is to say under the tread, that means carcass reinforcement reinforcing layers and crown reinforcement reinforcing layers of which the axial (or meridian) curvatures are practically concentric at all points on the profile of the wear surface and therefore that of the tread.

Conventional tires usually have an additional layer of rubber compound inserted under the tread, centered on the circumferential median plane. The presence of such a layer makes it possible to obtain a radius of axial curvature of the tread that is smaller than that of the axial curvature of the reinforcing layers in the crown reinforcement. Tires according to the invention have no such layer and this notably allows the tire to become lighter in weight. The absence of such a layer may also play a part in limiting the heating of the tire in use and therefore contribute to its endurance performance.

According to a preferred embodiment of the invention, the reinforcing elements of the layer of circumferential reinforcing elements are stranded cords exhibiting, between their initial state and their state when extracted from the tire, a reduction greater than 15 GPa and preferably greater than 20 GPa in the maximum tangent modulus.

The modulus values expressed hereinabove are measured on a tensile stress/elongation curve established with a preload of 5 N, the tensile stress corresponding to a tension divided by the cross section of metal in the reinforcing element. These measurements are taken under tension in accordance with 1984 ISO Standard ISO 6892.

The cords taken from tires on which the measurements are made are taken from tires of which the constituent parts, other than the cords concerned, and notably the compounds liable to penetrate the said cords are constituent parts that are conventional for applications of the heavy vehicle tire type.

Advantageously according to this embodiment of the invention, the reinforcing elements of the layer of circumferential reinforcing elements are stranded cords which are assembled by a twisting method that allows air into the cord.

Such a twisting method may notably involve twisting during the manufacture of the strands. The twisting method then essentially involves:

winding the threads of the outer layer in a helix onto an inner layer at a given transient twisting pitch,

overtwisting or creeping with a view to reducing this transient pitch, i.e. with a view to increasing the helix angle of the said outer layer and, therefore, the helix curvature thereof, and

stabilizing the strand obtained by untwisting in order to obtain a zero residual torque.

The twisting method may also relate to the assembling of the strands. The twisting method therefore essentially involves:

winding the strands at a given transient twisting pitch,

overtwisting or creeping with a view to reducing this transient pitch (i.e. with a view to increasing the helix angle of the assembly of strands and, therefore, the helix curvature), and

stabilizing the cord obtained by untwisting in order to obtain zero residual torque.

The twisting method may finally be a combination of a twisting during the creation of each of the strands and of a twisting during the assembly of the strands to obtain the cord.

The twisting method thus described which is implemented to obtain a cord according to the invention confers upon the threads that make up the outer layer of a strand and/or upon the strands that make up the cord a large curvature which parts them axially (the axial direction is then a direction perpendicular either to the direction of the axis of a strand in the case of the threads or perpendicular to the direction of the axis of the cord in the case of strands). This curvature is defined, on the one hand, by the helix diameter of this outer layer and, on the other hand, by the helix pitch or even by the helix angle of the said outer layer (angle measured from the axis of the cord).

It should be noted that the twisting method thus described makes it possible to increase both the helix diameter and the helix angle.

According to the invention, this helix angle is advantageously comprised between 25° and 45°.

The twisting method thus described applied to the threads that make up the strands and/or to the strands plays a part in significantly increasing the structural elongation of the cord, which is proportional to tan²(helix angle).

The inventors have been able to demonstrate that cords thus produced which exhibit between their initial state and their state when extracted from the tire, a reduction greater than 15 GPa in the maximum tangent modulus, as compared with cords of the same formula but produced without a twisting step and with lower helix pitches, exhibit higher structural elongations in the raw state and when extracted from the tire. Furthermore, while in their initial state these same cords according to the invention, still as compared with cords of the same formula but produced without a twisting step and with lower helix pitches, exhibit a higher maximum tangent modulus, when extracted from the tire may very surprisingly, by comparison with cords of the same formula but produced without a twisting step and with lower helix pitches, exhibit a lower maximum tangent modulus.

In the case of the tires according to the invention, in which the reinforcing layers of the crown reinforcement exhibit axial curvatures that are practically concentric at all points with the profile of the tread, the use of such cords will make it possible further to improve the endurance of the tires. This is because the maximum tangent modulus which is notably lower for cords extracted from the tire, combined with a greater structural elongation, as compared with cords of the same formula but produced without a twisting step and with lower helix pitches, will make it possible to reduce the tension experienced by the reinforcing elements in the layer of circumferential reinforcing elements, particularly at the ends of the said layer when this layer has a curved shape as it does in the case of the invention when passing through the contact patch which causes the tire to deform.

The use of such reinforcing elements in at least one layer of circumferential reinforcing elements also makes it possible to keep sufficient stiffness in the layer after the shaping and curing steps in the conventional manufacturing processes.

According to one advantageous embodiment of the invention, the reinforcing elements of at least one layer of circumferential reinforcing elements are metal reinforcing elements having a secant modulus at 0.7% elongation comprised between 10 and 120 GPa and a maximum tangent modulus of less than 150 GPa.

According to a preferred embodiment, the secant modulus of the reinforcing elements at 0.7% elongation is less than 100 GPa, and preferably greater than 20 GPa and more preferably still, comprised between 30 and 90 GPa, and more preferably still, less than 80 GPa.

For preference too, the maximum tangent modulus of the reinforcing elements is less than 130 GPa and more preferably still, less than 120 GPa.

The modulus values expressed hereinabove are measured on a tensile stress/elongation curve determined with a preload of 5 N, the tensile stress corresponding to a measured tension divided by the cross section of metal in the reinforcing element.

According to a preferred embodiment, the reinforcing elements of at least one layer of circumferential reinforcing elements are metal reinforcing elements exhibiting a tensile stress/relative elongation curve that has Shallow gradients for small elongations and a substantially constant and steep gradient for greater elongations. Such reinforcing elements in the additional ply are generally known as “bi-modulus” elements.

According to a preferred embodiment of the invention, the substantially constant and steep gradient appears starting from a relative elongation comprised between 0.4% and 0.7%.

The various characteristics of the reinforcing elements as mentioned hereinabove are measured on reinforcing elements taken from tires.

Reinforcing elements more particularly suited to producing at least one layer of circumferential reinforcing elements according to the invention are, for example, assemblies of formula 21.23, the construction of which is 3×(0.26+6×0.23) 5.0/7.5 SS; this stranded cord consists of 21 elementary threads of formula 3×(1+6), with 3 strands twisted together at a pitch of 7.5 mm, each strand consisting of 7 threads, one thread forming a central core with a diameter equal to 26/100 mm and 6 wound threads with a diameter equal to 23/100 mm at a pitch of 5 mm. Such a cord has a secant modulus equal to 45 GPa at 0.7% and a maximum tangent modulus equal to 100 GPa, these being measured on a tensile stress/elongation curve determined with a preload of 5 N, the tensile stress corresponding to a measured tension divided by the cross section of metal in the reinforcing element.

The invention advantageously makes provision for at least one layer that makes up the crown architecture to be present radially under the axially outermost “rib” or mainly longitudinally directed tread pattern. This embodiment improves the stiffness of the said tread pattern.

According to a preferred embodiment of the invention, the difference between the axial width of the axially widest working crown layer and the axial width of the axially narrowest working crown layer is comprised between 10 and 30 mm.

For preference too, the axially widest working crown layer is radially on the inside of the other working crown layers.

One advantageous embodiment of the invention has it that the axial width of at least one layer of circumferential reinforcing elements is less than the axial width of the axially widest working crown layer.

Such a width of at least one layer of circumferential reinforcing elements notably allows a reduction in shear stresses between the working layers and therefore as a result further improves the endurance performance of the tire.

The layer of circumferential reinforcing elements according to the invention is advantageously a layer that is continuous across all of its axial width.

According to an alternative form of the invention, at least one layer of circumferential reinforcing elements is laid radially between two working crown layers.

According to this alternative form, the layer of circumferential reinforcing elements makes it possible more greatly to limit the compression of the reinforcing elements in the carcass reinforcement than a similar layer laid radially on the outside of the working layers. It is preferably radially separated from the carcass reinforcement by at least one working layer so as to reduce the stress loadings of the said reinforcing elements and not subject them to excessive fatigue.

Advantageously too, in the case of a layer of circumferential reinforcing elements which is positioned radially between the two working crown layers, the axial widths of the working crown layers radially adjacent to the layer of circumferential reinforcing elements are greater than the axial width of the said layer of circumferential reinforcing elements, and for preference, the said working crown layers adjacent to the layer of circumferential reinforcing elements are, on each side of the equatorial plane and in the immediate axial continuation of the layer of circumferential reinforcing elements, coupled over an axial width and then decoupled by profiled elements of rubber compound at least over the remainder of the width common to the said two working layers.

The presence of such couplings between the working crown layers adjacent to the layer of circumferential reinforcing elements allows a further reduction in the tensile stress applied to the axially outermost circumferential elements situated closest to the coupling.

The thickness of the profiled elements that provide the decoupling between working plies, measured at the ends of the narrowest working ply, was at least equal to two millimeters, and preferably greater than 2.5 mm.

Coupled plies are to be understood to mean plies the respective reinforcing elements of which are radially separated by 1.5 mm at the most, the said thickness of rubber being measured radially between the respectively upper and lower generatrices of the said reinforcing elements.

In order to reduce the tensile stresses applied to the axially outermost circumferential elements, the invention also advantageously plans for the angle formed with the circumferential direction by the reinforcing elements of the working crown layers to be less than 30° and preferably less than 25°.

According to another advantageous alternative form of the invention, the working crown layers comprise reinforcing elements, which are crossed from one ply to the other, and make, with the circumferential direction, angles that can vary in the axial direction, the said angles being greater on the axially outer edges of the layers of reinforcing elements by comparison with the angles of the said elements measured at the circumferential median plane. Such an embodiment of the invention makes it possible to increase the circumferential stiffness in certain regions but decrease it in others, notably in order to reduce the compression loadings on the carcass reinforcement.

One preferred embodiment of the invention also has it that the crown reinforcement is supplemented radially on the outside by at least one additional ply, known as a protective ply, of reinforcing elements that are said to be elastic, which are directed at an angle comprised between 10° and 45° with respect to the circumferential direction and in the same direction as the angle formed by the inextensible elements of the working layer radially adjacent to it.

The protective layer may have an axial width smaller than the axial width of the narrowest working layer. The said protective layer may also have an axial width greater than the axial width of the narrowest working layer, such that it overlaps the edges of the narrowest working layer and, in the event that it is the radially upper layer that is the narrowest, such that it is coupled, in the axial continuation of the additional reinforcement, to the widest working crown layer over an axial width and then axially on the outside decoupled from the said widest working layer by profiled elements at least 2 mm thick. The protective layer formed of elastic reinforcing elements may, in the abovementioned instants, be, on the one hand, possibly decoupled with the edges of the said narrowest working layer by profiled elements of a thickness substantially less than the thickness of the profiled elements that separate the edges of the two working layers and, on the other hand, have an axial width that is less than or greater than the axial width of the widest crown layer.

According to either one of the embodiments of the invention mentioned hereinabove, the crown reinforcement may further be supplemented, radially on the inside between the carcass reinforcement and the radially inner working layer closest to the said carcass reinforcement, by a triangulation layer of inextensible metal reinforcing elements made of steel which make, with the circumferential direction, an angle greater than 60° and in the same direction as that of the angle formed by the reinforcing elements of the radially closest layer of the carcass reinforcement.

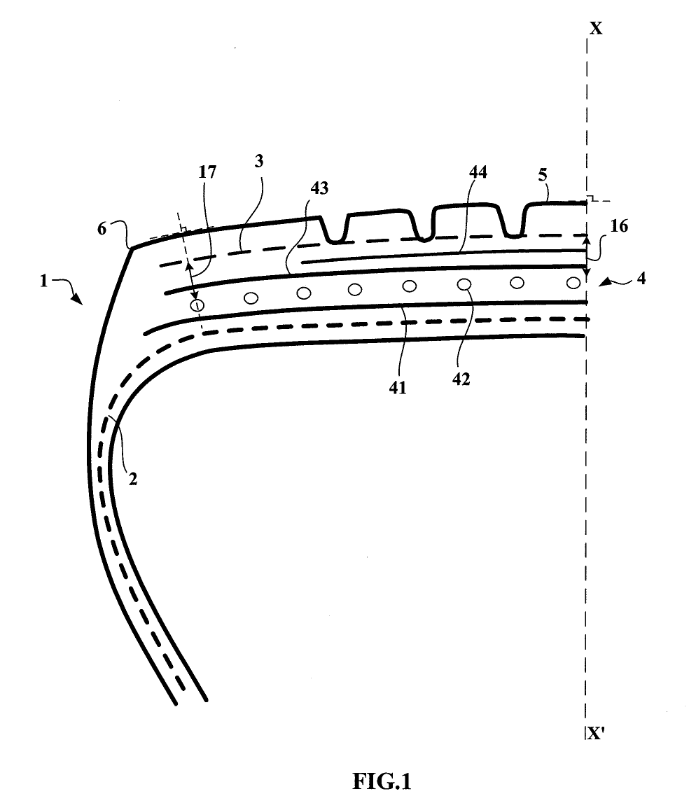

Other advantageous features and details of the invention will become apparent hereinafter from the description of one embodiment of the invention given with reference to FIGS. 1 to 3 which depict:

FIG. 1: a meridian view of a diagram of a tire according to the invention,

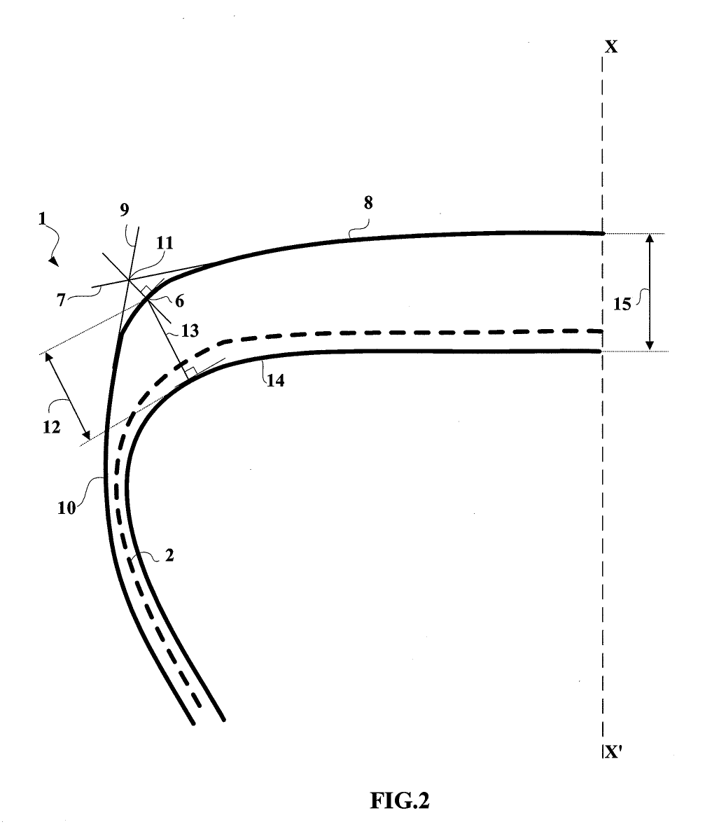

FIG. 2: a meridian view of a simplified diagram of the tire of FIG. 1,

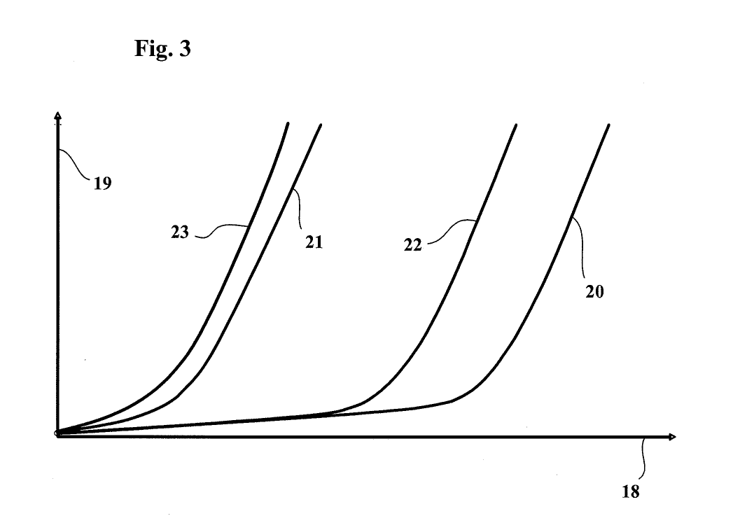

FIG. 3: a diagram illustrating force/elongation curves for cords according to the invention and conventional cords.

To make them easier to understand, the figures are not drawn to scale. The figures depict only a half view of a tire which continues symmetrically with respect to the axis XX′ which represents the circumferential median plane, or equatorial plane, of a tire.

In FIG. 1, the tire 1, of size 315/70 R 22.5 XF, has an aspect ratio H/S equal to 0.70, H being the height of the tire 1 on its mounting rim and S being its maximum axial width. The said tire 1 comprises a radial carcass reinforcement 2 anchored in two beads, not depicted in the figure. The carcass reinforcement is formed of a single layer of metal cords. This carcass reinforcement 2 is wrapped with a crown reinforcement 4, formed radially from the inside outwards:

of a first working layer 41 formed of unwrapped inextensible metal 11.35 cords which are continuous across the entire width of the ply, and directed at an angle equal to 18°,

of a layer of circumferential reinforcing elements 42 which is formed of 21×23 metal cords made of steel, of the “bi-modulus” type,

of a second working layer 43 formed of unwrapped inextensible metal 11.35 cords which are continuous across the entire width of the ply, directed at an angle equal to 18° and crossed with the metal cords of the layer 41,

of a protective layer 44 made of elastic metal 18×23 cords.

The crown reinforcement is itself capped by a tread 5.

The axial width L₄₁ of the first working layer 41 is equal to 248 mm, which, for a tire of a conventional shape, is substantially less than the width L of the tread which, in the case under investigation, is equal to 262 mm. The difference between the width of the tread and the width L₄₁ is therefore equal to 14 mm and therefore less than 15 mm according to the invention.

The axial width L₄₃ of the second working layer 43 is equal to 230 mm. The difference between the widths L₄₁ and L₄₃ is equal to 18 mm and therefore comprised between 10 and 30 mm according to the invention.

As for the overall axial width L₄₂ of the layer of circumferential reinforcing elements 42, this is equal to 188 mm.

The last crown ply 44, known as the protective ply, has a width L₄₄ equal to 188 mm.

According to the invention, across the entire width of the layer of reinforcing elements 42, all of the layers of the crown reinforcement have a radius of curvature practically identical to that of the tread.

FIG. 1 also illustrates the extreme wear surface 3; this is extrapolated from the wear indicators present in the tire but which have not been depicted in the figures.

FIG. 2 is a meridian view of a simplified diagram of the tire 1 depicting a first tangent 7 to the surface of an axially outer end of the tread 8; the surface of the tread is defined by the radially outer or top surface of the tread patterns, not depicted in this simplified diagram of FIG. 2. A second tangent 9 to the surface of the radially outer end of a sidewall 10 intersects the first tangent 7 at a point 11. The orthogonal projection onto the exterior surface of the tire defines the shoulder end 6.

FIG. 2 thus indicates the measurement of the thickness of the crown block at a shoulder end 6, defined by the length 12 of the orthogonal projection 13 of the shoulder end 6 onto the layer of rubber compound 14 radially furthest towards the inside of the tire.

FIG. 2 also shows the measurement of the thickness of the crown block in the circumferential median plane XX′, defined as being the distance 15 in the radial direction between the tangent to the top of the tread 8 in the circumferential median plane and the tangent to the rubber compound 14 radially furthest towards the inside of the tire, in the circumferential median plane.

According to the invention, the measurements of thickness 12 of the crown block at each of the shoulder ends 6 are equal to 39.4 mm. In the circumferential median plane XX′, the measurement of thickness 15 of the crown block is equal to 31.7 mm. The ratio of the thickness of the crown block at a shoulder end to the thickness of the crown block in the circumferential median plane is equal to 1.24 and therefore greater than 1.2.

Once again according to the invention, the ratio of the distance 16 between the extreme wear surface and the reinforcing elements of the layer of circumferential reinforcing elements in the circumferential median plane to the distance 17 between the extreme wear surface and the reinforcing elements of the layer of circumferential reinforcing elements at the ends of the said layer of circumferential reinforcing elements is equal to 1 and therefore comprised between 0.95 and 1.05. Specifically, the distances 16, 17 between the extreme wear surface and the reinforcing elements of the layer of circumferential reinforcing elements in the circumferential median plane and at the ends of the said layer of circumferential reinforcing elements respectively, are identical to each other and equal to 10 mm.

FIG. 3 is a graph of the strength/elongation curves for a cord according to one alternative form of the invention to form the layer of circumferential reinforcing elements that has been assembled by twisting, as described previously, as compared with a cord of the same formula in more commonplace use in this type of application.

This graph illustrates the elongation 18 observed for a force 19 applied in tension to the cord in accordance with 1984 ISO Standard ISO 6892.

The cord according to the invention is a 21×23 steel cord of the “bi-modulus” type the construction of which is 3×(0.26+6×0.23) 5.0/7.5 SS; this stranded cord is made up of 21 elementary threads of 3×(1+6), with 3 strands twisted together at a pitch of 7.5 mm, each strand being made up of 7 threads, one thread forming the central core of a diameter equal to 26/100 mm and 6 wound threads of a diameter equal to 23/100 mm at a pitch of 5 mm.

The reference cord with which it is compared is a steel cord of the same 21×23 formula, of the “bi-modulus” type, with the construction 3×(0.26+6×0.23) 4.4/6.6 SS.

Curve 20 corresponds to the cord according to the invention in its initial state and curve 21 corresponds to the same cord extracted from the tire, this cord being impregnated with rubber and having undergone the curing of the tire.

Likewise, curves 22 and 23 correspond to the reference cord, in its initial state and in the state in which it is extracted from the tire, respectively.

It is clear from these curves that the structural elongation of the cord according to the invention is greater than that of the reference cord. Moreover, the elastic modulus, or maximum tangent modulus, of the cord according to the invention is equal to 100 GPa whereas that of the reference cord is equal to 90 GPa.

These differences in value can be explained by the method of assembly by twisting in the case of the cord according to the invention and differences in the assembly pitch, these being greater in the case of the cord according to the invention.

Concerning measurements taken from cords extracted from the tire, the structural elongation of the cord according to the invention remains higher but the value of the maximum tangent modulus becomes lower for the cord according to the invention as compared with that of the reference cord; 78 GPa for the cord according to the invention as compared with 85 GPa for the reference cord.

The appreciably lower maximum tangent modulus for cords extracted from the tire, combined with a greater structural elongation, as compared with cords of the same formula but produced without a twisting step and with lower helix pitches, will make it possible to reduce the tensions experienced by the reinforcing elements in the layer of circumferential reinforcing elements, notably at the ends of the said layer when this layer is of a curved shape as it is in the invention when it passes through the contact patch which causes the tire to deform.

According to the invention, the cords according to the invention exhibit, between their initial state and the state in which they are extracted from the tire, a reduction equal to 22(100-78) and therefore of more than 15 GPa in the maximum tangent modulus.

Tests have been carried out with the tire produced according to the invention in accordance with the depiction of FIG. 1, comprising a layer of circumferential reinforcing elements produced with reinforcing cords according to the invention as have just been described. Identical tests were carried out with a reference tire that was identical but produced with a different configuration in which the cords of the layer of circumferential reinforcing elements were the reference cords described hereinabove and all the layers that made up the reinforcement had radii of curvature that differed from that of the surface of the tread, these radii of curvature being mere-infinite.

The mass of the tire according to the invention is 2% less than that of the reference tire.

Initial trials involved carrying out flywheel rolling tests on each of the tires and causing them to follow routes equivalent to straight-line paths, the tires being subjected to loadings heavier than the nominal loading in order to accelerate this type of test.

The loading per tire was 3800 kg at the start of the run and increased up to a loading of 4800 kg at the end of the run.

The results of these initial tests demonstrated that the results obtained for the two types of tire were comparable.

Further endurance testing was carried out on a testing machine that applied a loading and a cornering angle to the tires.

The results obtained once again showed that the two types of tires exhibited very similar results.

1. A tire with radial carcass reinforcement comprising a crown reinforcement formed of at least two working crown layers of inextensible reinforcing elements, which are crossed from one ply to the other making angles of between 10° and 45° with the circumferential direction, itself radially capped by a tread, said tread being connected to two beads by two sidewalls, the crown reinforcement comprising at least one layer of circumferential reinforcing elements, wherein the ratio of the thickness of the crown block at a shoulder end to the thickness of the crown block in the circumferential median plane is greater than 1.20 and wherein the ratio of the distance between the extreme wear surface and the reinforcing elements of the layer of circumferential reinforcing elements in the circumferential median plane to the distance between the extreme wear surface and the reinforcing elements of the layer of circumferential reinforcing elements at the ends of the said layer of circumferential reinforcing elements is comprised between 0.95 and 1.05.

2. The tire according to claim 1, wherein the reinforcing elements of the layer of circumferential reinforcing elements are stranded cords exhibiting, between their initial state and their state when extracted from the tire, a reduction greater than 15 GPa and preferably greater than 20 GPa in the maximum tangent modulus.

3. The tire according to claim 1, wherein the reinforcing elements of at least one layer of circumferential reinforcing elements are metal reinforcing elements having a secant modulus at 0.7% elongation comprised between 10 and 120 GPa and a maximum tangent modulus of less than 150 GPa.

4. The tire according to claim 3, wherein the secant modulus of the reinforcing elements at 0.7% elongation is less than 100 GPa, preferably greater than 20 GPa and more preferably still, comprised between 30 and 90 GPa.

5. The tire according to claim 3, wherein the maximum tangent modulus of the reinforcing elements is less than 130 GPa and preferably less than 120 GPa.

6. The tire according to claim 1, wherein the reinforcing elements of the said layer of circumferential reinforcing elements are metal reinforcing elements exhibiting a tensile stress/relative elongation curve that has shallow gradients for small elongations and a substantially constant and steep gradient for greater elongations.

7. The tire according to claim 1, wherein the axially widest working crown layer is radially on the inside of the other working crown layers.

8. The tire according to claim 1, wherein the difference between the axial width of the axially widest working crown layer and the axial width of the axially narrowest working crown layer is comprised between 10 and 30 mm.

9. The tire according to claim 1, wherein the axial width of at least one layer of circumferential reinforcing elements is less than the axial width of the axially widest working crown layer.

10. The tire according to claim 1, wherein at least one layer of circumferential reinforcing elements is laid radially between two working crown layers.

11. The tire according to claim 10, wherein the axial widths of the working crown layers radially adjacent to the layer of circumferential reinforcing elements are greater than the axial width of the said layer of circumferential reinforcing elements.

12. The tire according to claim 11, wherein the working crown layers adjacent to the layer of circumferential reinforcing elements are, on each side of the equatorial plane and in the immediate axial continuation of the layer of circumferential reinforcing elements, coupled over an axial width and then decoupled by profiled elements of rubber compound at least over the remainder of the width common to the said two working layers.

13. The tire according to claim 1, wherein the crown reinforcement is supplemented radially on the outside by at least one additional ply, known as a protective ply, of reinforcing elements that are said to be elastic, which are directed at an angle comprised between 10° and 45° with respect to the circumferential direction and in the same direction as the angle formed by the inextensible elements of the working ply radially adjacent to it.

14. The tire according to claim 1, wherein the crown reinforcement further comprises a triangulation layer formed of metal reinforcing elements that make angles greater than 60° with the circumferential direction.
